(19) United States
(12) Patent Application Publication
(10) Pub. No.: US 2013/0061228 A1
(43) Pub. Date: Mar. 7, 2013

(54) OPERATING SYSTEM IMAGE MANAGEMENT

(71) Applicants: Rahul Prasad, Seattle, WA (US); William K. Cheng, Seattle, WA (US)

(72) Inventors: Rahul Prasad, Seattle, WA (US); William K. Cheng, Seattle, WA (US)

(73) Assignee: Microsoft Corporation, Redmond, WA (US)

(21) Appl. No.: 13/223,896

(22) Filed: Sep. 1, 2011

(51) Int. Cl. G06F 9/46

(52) U.S. Cl. 718/100

(57) ABSTRACT

Some embodiments of the invention enable multiple operating system images to be concurrently serviced. For example, a user may “mount” a group comprising multiple images to be serviced, alter the group of images in some fashion, and then re-seal each image in the group. Some embodiments of the invention provide a programmatic interface which may be employed to enhance image servicing functionality. For example, some embodiments provide an application programming interface (API) which exposes functionality that is call-able by external software components, enabling use of a custom-developed interface, code providing additional image servicing functionality, and/or any of numerous other types of image servicing-related functionality.

### BACKGROUND

An operating system image is a representation of the state of an operating system at a particular point in time, generally stored in non-volatile form. An operating system image typically includes the files, directory layout and associated file system metadata employed by the operating system. Images of Microsoft Windows-family operating systems, offered by Microsoft Corporation of Redmond, Wash., are often stored using the proprietary Windows Imaging Format (WIM) or Virtual Hard Disk (VHD) format. Images of other operating systems may be stored in other formats.

Often, after a new version of an operating system version is made publicly available, one or more images of the operating system are provided to customers, so that the new version can be installed on one or more computers. Some customers may wish to alter an image after its public release. For example, customers such as original equipment manufacturers (OEMs) may wish to update certain code within an operating system image, add drivers or applications, enable certain features that were disabled in the publicly released version (or vice versa), install one or more service packs made available after the image was released, add language packs to support users in certain geographic regions where the operating system may be sold, and/or make any of numerous other types of alterations. After an operating system image is altered, it may be installed by the customer on one or more computers. For example, an OEM may install a given operating system image on multiple computers of a given type that are to be offered for sale.

Various tools are known which allow users to service operating system images. Generally, these tools allow users to “mount” an operating system image, alter it in some way, and then “re-seal” the altered image so that it may thereafter be installed on one of more computers for execution. For example, the Deployment Image Servicing and Management (DISM) tool offered by Microsoft Corporation provides functionality relating to the servicing of operating system images.

### SUMMARY

The inventors have recognized that conventional tools for servicing an operating system image have several key limitations. For example, conventional tools do not enable a user to make changes to more than one operating system image at a time. As an example, if a customer such as an OEM maintained ten different operating system images (e.g., for ten different versions of the operating system for installation on different types of computers), and wished to alter all ten (e.g., to add a service pack newly released by the operating system provider), then the OEM would need to alter each image separately in turn using conventional tools. That is, the OEM would need to mount a first image, alter it, re-seal it, and then move on to perform the same operation on a second image, and so on until all images were serviced. This is inefficient.

In addition, conventional tools for servicing an operating system image provide access to a closed and relatively limited suite of functionality. For example, at least one existing tool provides a “command line” interface that allows a user to employ various modules for servicing an image. These modules are included within the image itself. Upon initialization of the tool, various modules included in the image are loaded for use, and may then be invoked via instructions entered to the command line interface to perform such tasks as adding a language pack, removing a feature from the image, etc. However, the only way to add functionality to the tool is to add modules, which requires adding code to the operating system, which can be costly and time-consuming. Using conventional approaches, only the operating system manufacturer can improve an image servicing tool, and not customers.

Some embodiments of the present invention enable multiple operating system images to be concurrently serviced. This feature may be of great value to customers which maintain a large number of images, such as OEMs, which may manage thousands of different operating system images at one time. In accordance with some embodiments of the invention, a user may “mount” multiple images concurrently, perform one or more actions on all of the images in the group, and then re-seal the images after the update has been applied. An image need not be “online” (i.e., executing) to be serviced, as “offline” images may be mounted for servicing. As a result, servicing large numbers of images may consume considerably less time and resources than when conventional approaches are used.

Some embodiments of the invention also, or alternatively, provide a programmatic interface which a user may employ to add or otherwise modify image servicing functionality. For example, some embodiments of the invention provide an application programming interface (API) which exposes functionality that may be called from external software components (e.g., developed by the user). This may provide numerous benefits. For example, a user such as an OEM may implement a custom interface, develop custom modules to provide additional image servicing functionality, etc., while still being able to rely on existing underlying infrastructure for servicing images.

The foregoing is a non-limiting summary of the invention, some embodiments of which are defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram depicting an example operating system image servicing system architecture, in accordance with some embodiments of the invention;

FIG. 2 is a flowchart depicting an example technique for servicing one or more operating system images, in accordance with some embodiments of the invention;

FIG. 3 is a sequence diagram depicting an example technique for invoking an example image servicing command thread, in accordance with some embodiments of the invention;

FIG. 4 is a sequence diagram depicting an example technique for initializing an image servicing command thread, in accordance with some embodiments of the invention;

FIG. 5 is a sequence diagram depicting an example technique for shutting down an image servicing command thread, in accordance with some embodiments of the invention; and

FIG. 6 is a block diagram depicting an example computer which may be used to implement certain aspects of the invention.

### DETAILED DESCRIPTION

Some embodiments of the invention enable multiple operating system images to be concurrently serviced. For example, a user may “mount” a group of images to be serviced, alter the group of images in some fashion, and then re-seal each image in the group. Further, some embodiments enable the images in the group to be serviced without having to boot. As such, embodiments of the invention may enable large numbers of images to be serviced more efficiently than conventional approaches allow.

Some embodiments of the invention provide a programmatic interface which may be employed to enhance image servicing functionality. For example, some embodiments provide an application programming interface (API) which exposes functionality that is call-able by external software components. As such, users may implement a custom-developed interface, code providing additional image servicing functionality, and/or any of numerous other types of image servicing-related functionality. This may, for example, insulate users from underlying processes performed to service images, and simplify the overall procedure from the user's perspective.

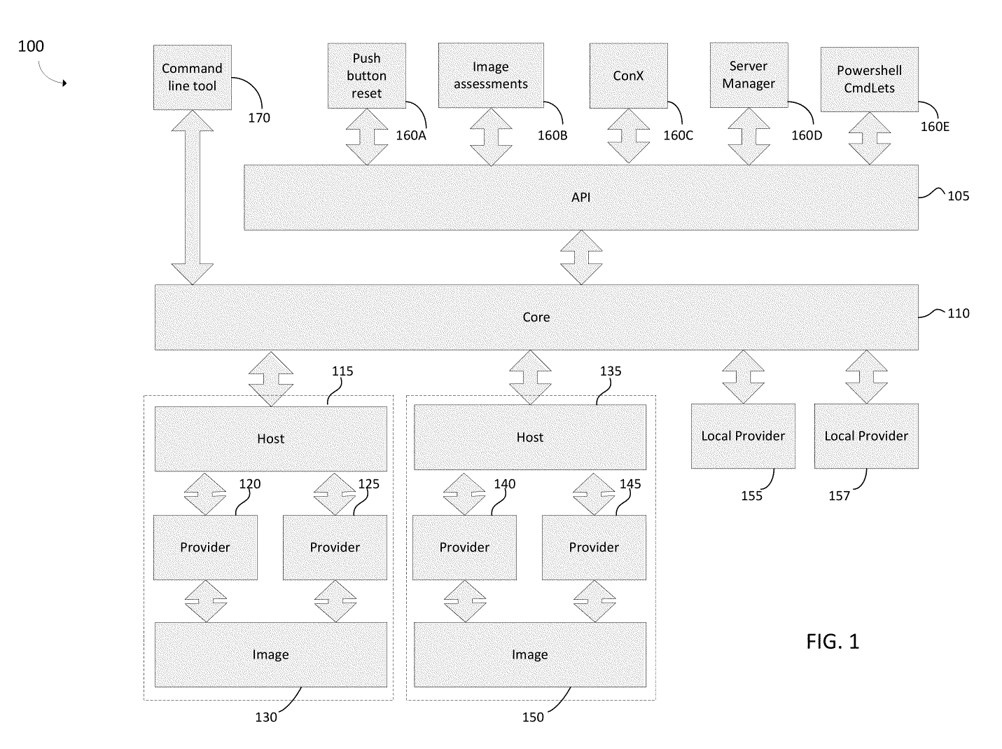

FIG. 1 depicts an example system architecture 100 for providing image servicing functionality. Example architecture 100 may, for example, enable concurrent servicing of multiple operating system images, and provide a programmatic interface enabling customized extension of image servicing functionality. Example architecture 100 includes application programming interface (API) 105. As those skilled in the computer programming arts will appreciate, API 105 may expose any of numerous types of functionality to one or more external (e.g., custom developed) components, allowing those components to exploit that functionality. For example, API 105 may expose various types of functionality relating to servicing images, enabling the development of a custom interface providing access to that functionality.

In example architecture 100, some example components 160A-160E that provide functionality relating to servicing images are shown. However, it should be appreciated that any number of components may be provided and/or employed, and that the components may provide any type of functionality, including functionality not provided by the example components shown.

Push button reset component 160A enables maintenance of a known good copy of an original installation image, which may also include one or more applications. This may be useful, for example, if servicing an image over time causes it to acquire a defect. By “resetting” the image, it may be restored to a known good state, albeit in a modified form in which it is not vulnerable to security threats. Image assessments component 160B enable a quality assessment of one or more images, which may be performed, for example, by querying driver status and other properties, so as to get an accurate quality assessment without having to boot an image. ConX component 160C provides various image setup capabilities, such as by transferring components (e.g., drivers) from an existing (e.g., currently executing) operating system image to a target operating system image to be set up. Server manager component 160D provides functionality relating to managing server components. Powershell command lets component 160E provides a scripting and shell environment through which various types of image servicing commands may be issued.

API 105 communicates with core 110 to transfer instructions originating at any one or more of components 160A-160E to a host corresponding to a particular operating system image. In example architecture 100 shown in FIG. 1, there are two hosts (i.e., hosts 115 and 135), each corresponding to a separate image (i.e., images 130 and 150, respectively). Thus, API 105 communicates instructions originating at one of components 160 via core 110 to host 115 to service image 130, and via core 110 to host 135 to service image 150. It should be appreciated that although core 110 is used to communicate commands in the example architecture shown, any suitable component(s) may alternatively be employed. It should also be appreciated that although only two hosts and corresponding images are depicted in FIG. 1, embodiments of the invention may enable the servicing of any suitable number of hosts, each corresponding to any suitable number of images.

As FIG. 1 indicates, a command line interface 170 enables a user to issue image servicing instructions for delivery via core 110 to one or more of hosts 115 and 135, to service image 130 and/or 150. For example, a user may submit instructions to modify images 130 and/or 150 by removing a driver, adding a language pack, etc., and these instructions may be passed by core 110 to the appropriate host(s) for the image.

In some embodiments, each host comprises a set of programmed instructions which, when executed, oversees the execution of one or more providers. Each provider may comprise one or more modules, callable by the host, to perform a particular type of image servicing-related task. For example, a provider may be called by a host to perform tasks such as nationalization (e.g., adding a language pack), adding, deleting and/or modifying one or more drivers, enabling or disabling features within an image, etc. In the example shown in FIG. 1, host 115 corresponding to image 130 oversees the execution of providers 120 and 125, and host 135 corresponding to image 150 oversees the execution of providers 140 and 145. Although each host shown in FIG. 1 oversees the execution of two providers, it should be appreciated that a host may oversee the execution of any suitable number of providers, as embodiments of the invention are not limited in this respect.

In some embodiments, a host and/or one or more providers corresponding to an image may be extracted from the image itself. For example, in some embodiments, API 105 may extract a host and/or provider(s) from an image for use in servicing that image, thereby exposing functionality made available by the providers to external components. In this respect, in the example architecture shown in FIG. 1, API 105 may receive commands from one or more of components 160, such as instructions to employ functionality exposed by API 105. Each of components 160 may comprise, for example, a custom-developed module and/or a module which is integrated with or otherwise provided for use with API 105. In this respect, any of the components, hosts and/or providers shown in FIG. 1 may be provided by any suitable source.

It should be appreciated that an image serviced using the example architecture shown in FIG. 1 may be any type of operating system image. For example, an image may be of a Microsoft Windows-family operating system, an Apple Mac operating system, a Linux operating system, or any other operating system. As such, an image to be serviced may comply with any suitable image format, whether now known or later developed.

It should further be appreciated that an image need not be online (i.e., executing), or offline, to be serviced. In this respect, some embodiments of the invention may service one or more images that are offline, one or more images that are online, or a combination thereof. For example, in FIG. 1, image 130 may be offline, and image 150 may be online, and these images may be serviced concurrently.

Providing a capability to service offline images may prove valuable in certain contexts. For example, in some implementations, a number of virtual machines may reside on a server (e.g., to perform such tasks as web hosting), with each virtual machine including an operating system image. At any one time, the operating system for a given virtual machine may or may not be executing. By allowing offline images to be serviced, embodiments of the invention enable the operating systems on non-active virtual machines to be kept up to date, by implementing modifications as needed.

As noted above, in some embodiments of the invention, more than one image may be serviced concurrently. In some embodiments, API 105 enables concurrent servicing of multiple images by assigning each image a handle which may be used to reference the image. A handle may comprise any suitable identifier or combination of identifiers, each employing any suitable information to identify an image. For example, a handle may comprise one or more integers, alphanumeric strings, codes, pointers, proxy classes, objects, and/or any other means of identifying an image.

In some embodiments of the invention, when a component 160 calls an API function to mount a particular image for servicing, API 105 assigns the image a handle, and provides the handle to component 160. The component thereafter references the image using the handle, and API 105 manages the delivery of instructions to a referenced image. Performance of an operation on more than one image may, for example, be initiated via multiple requests that each reference a different handle, a single request that references multiple handles, and/or using any other suitable technique that indicates that the operation is to be performed on multiple images. Of course, embodiments of the invention need not employ a unique handle to reference images, as any suitable technique may be used to discriminate among and/or group operating system images for servicing.

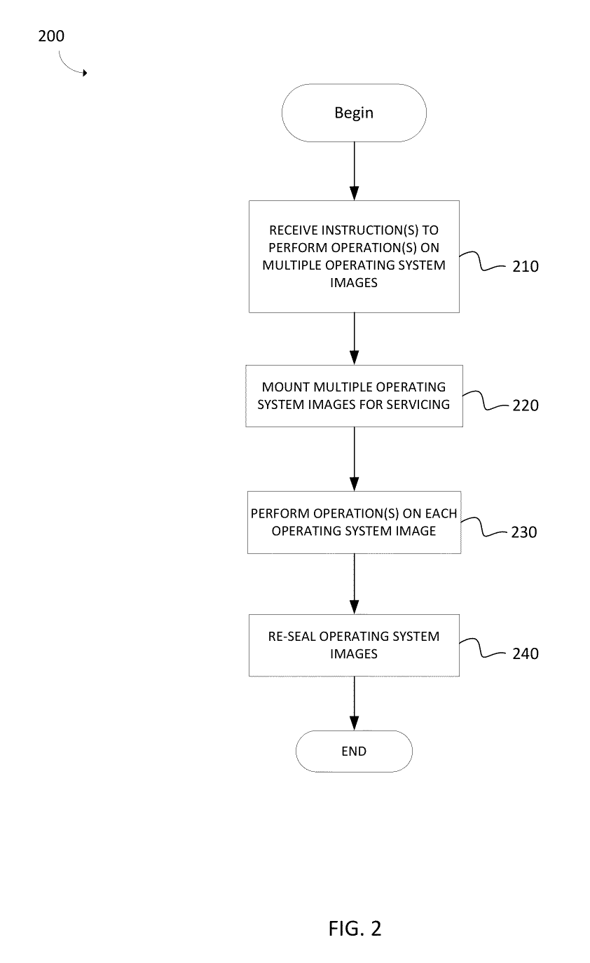

An example technique 200 for concurrently performing one or more operations on multiple operating system images is shown in FIG. 2. At the start of example technique 200, in act 210, one or more instructions are received at API 105, to perform one or more operations on multiple operating system images (e.g., images 130, 150). For example, each of the operating system images may be referenced by a handle assigned by API 105, and the instruction(s) may reference the handle for each operating system image. In act 220, the plurality of operating system images are mounted for servicing. In act 230, the one or more operations, or some subset thereof, is performed on each of the plurality of operating system images. In this respect, it should be appreciated that example technique 200 may involve performing a different operation, or combination of operations, on each of the multiple operating system images. For example, a first operation may be performed on one operating system image, and a combination of operations (which may or may not include the first operation) may be performed on another operating system image. Embodiments of the invention are not limited to performing the same operation(s) on each of the multiple operating system images that are serviced.

It should also be appreciated that “concurrent” performance of one or more operations on a plurality of operating system images in act 230 need not involve the operation(s) being performed simultaneously on the multiple operating system images. In some embodiments of the invention, the time period during which an operation is performed on one of the multiple operating system images overlaps with the time period during which an operation is performed on another of the multiple operating system images. However, any suitable technique may be employed for concurrently performing one or more operations on multiple operating system images, as embodiments of the invention are not limited in this respect.

At the completion of act 230, example technique 200 proceeds to act 240, wherein the operating system images are re-sealed. This may be performed using any suitable technique. Example technique 200 then completes.

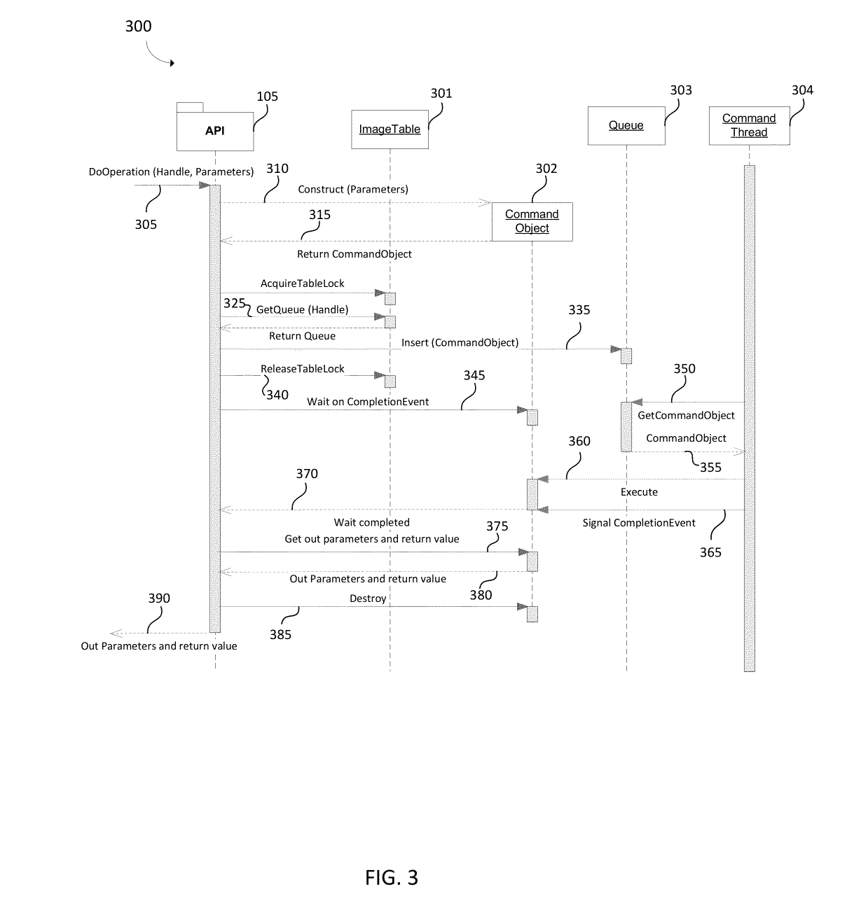

Example techniques for mounting and performing operations on an operating system image are described below with reference to FIGS. 3-5.

In addition to allowing a given operation to be performed on a plurality of images, some embodiments of the invention may support a second level of concurrency whereby more than one operation may be performed on a given image at a time. For example, while a first operation is being performed to add a service pack to an image, another operation to remove a driver from the same image may be initialized. In some embodiments, this may be accomplished by serializing the operations. Serialization may, for example, prevent conflicting operations from being performed on an image, which could result in the image being corrupted. For example, attempting to simultaneously install a service pack to an image and remove the same service pack from the image could result in the image being corrupted, since the removal operation may modify or delete information expected by the installation operation.

Serialization may be particularly helpful when an image to be serviced is offline. In this respect, when an image is online, it may be possible for one process to determine whether a certain file included in the image is in use by another process, whether another process is currently running, etc. Generally, when an image is offline, this information is unavailable, increasing the risk associated with performing concurrent operations on the image. By serializing operations, embodiments of the invention may help prevent corrupting an image while servicing.

It should be appreciated, however, that embodiments of the invention are not limited to serializing operations to avoid conflicts. Any of numerous techniques may alternatively be employed. For example, one or more of the providers employed to perform operations on an image could be modified to allow multiple concurrent operations to be performed on an image at a given time.

In embodiments in which serialization is performed, serialization may be accomplished by queuing operations. Of course, the invention is not limited to use of a queue (or queues), as any suitable serialization technique may be employed. For example, while one operation is being performed on an image, all subsequently initiated operations may be blocked, so that only one operation is performed at a time. Any suitable serialization technique may be employed.

In embodiments in which queuing is performed, operations may be placed into a queue in the order in which they are received at API 105. For example, if an instruction to perform a first operation is received by API 105 before an instruction to perform a second operation, then the first operation may be placed into the queue (and thus executed) prior to the second operation. Of course, embodiments of the invention are not limited to performing operations in the order in which corresponding instructions are received, as any suitable criteria for sequencing operations may be employed.

In some embodiments of the invention, API 105 manages a dedicated process thread for each image. Using the example shown in FIG. 1 to illustrate, API 105 may manage a first process thread for image 130, and a second process thread for image 150. A separate queue may be managed for each image. Each requested operation relating to an image is translated by API 105 into a command object, which is then placed in the queue for the image. As an example, if requests to perform five separate operations on image 130 were received, then a command object may be created for each operation, and each command object may be placed into the queue for image 130 (e.g., in an order in which the corresponding requests were received by API 105). To service image 130, API 105 then may read each command object in sequence from the queue (e.g., as a preceding operation completes), and execute the command object as part of the dedicated processing thread for image 130.

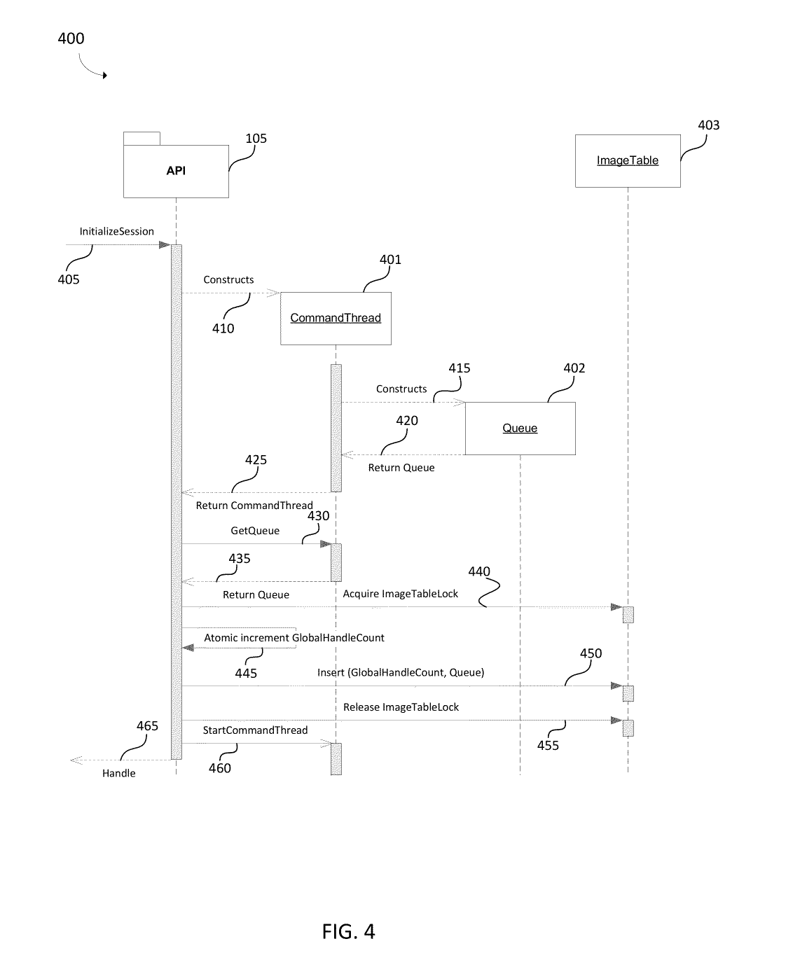

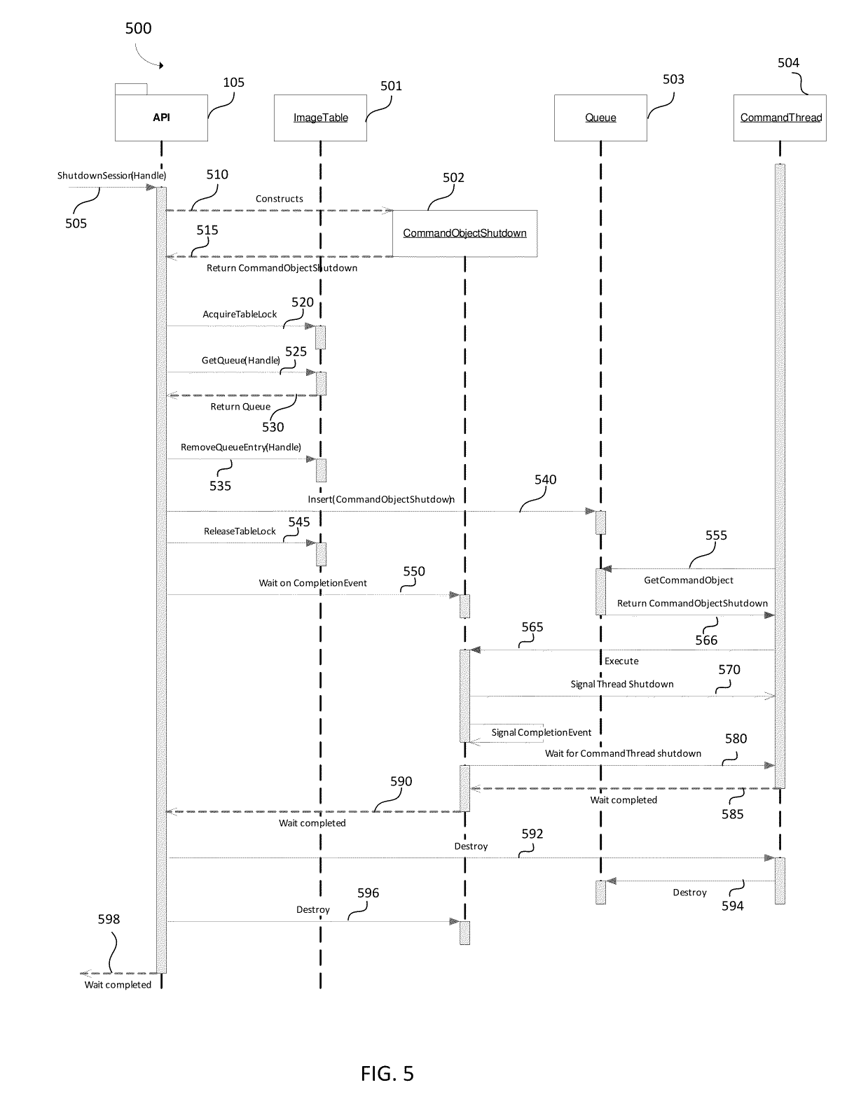

FIG. 3 is sequence diagram depicting an example technique for receiving an instruction to perform an operation on an image, mounting the image, and performing the operation on the image. FIG. 3 depicts API 105, an image table 301, a command object 302, a queue 303 and a command thread 304. Like FIGS. 4 and 5 below, FIG. 3 depicts components as separate to provide a conceptual understanding of how these components may interact in some embodiments of the invention. However, it should be appreciated that these components may not be “separate” in the sense that they are standalone components, or execute independently of one another. For example, in some embodiments of the invention, one or more of image table 301, command object 302, queue 303, and command thread 304 may be implemented by, and have execution managed by, API 105. Components depicted in FIGS. 3-5 may be implemented in any of numerous ways, as embodiments of the invention are not limited in this respect.

At the start of example technique 300, an instruction to perform an operation is received by API 105 (e.g., from one of components 160). In this example technique, the instruction includes various parameters, including a handle identifying a particular image upon which the operation is to be performed, and one or more operation-specific parameters.

Example technique 300 then proceeds to act 310, wherein API 105 constructs a command object for the requested operation. In some embodiments of the invention, a different type of command object may be constructed for each type of function call exposed by API 105. For example, there may be a first type of command object to add a language pack, a second type of command object to remove a driver, etc. Example technique 300 then proceeds to act 315, wherein an indication that the command object has been created is passed to API 105.

API 105 then identifies the queue corresponding to the handle referenced by the instruction received in act 305. Specifically, in act 320, API 105 acquires a lock on image table 301, which provides a cross-reference between handles and queues. API 105 then queries image table 301 to determine the queue corresponding to the handle. The queue (in this example, queue 303) is returned to API 105 in act 330, and API 105 inserts the command object into queue 303 in act 335. API 105 then releases the lock on image table 301 in act 340, and awaits an indication that the command object has completed in act 345.

At any one time, queue 303 has a set of commands “in flight,” and command thread 304 reads objects from the queue and executes them. In the example technique shown, command thread 304 issues an instruction to read command object 302 in queue 303 in act 350, and receives command object 302 in act 355.

As noted above, a command object may be executed to perform any of numerous types of operations on an image. For example, to add a service pack to an image (e.g., image 130, FIG. 1), command object 302 may issue an instruction via core 110 to host 115 to invoke one or providers 120, 125 to add a service pack to image 130. Similarly, to remove a driver from image 150, command object 302 may issue an instruction via core 110 to host 135 to invoke one or more of providers 140, 145 to remove a driver from image 150. Any of numerous types of operations may be performed on an image using a command object.

In act 365, command thread 304 indicates that execution of command object 302 has completed, and command object 302 provides a similar indication to API 105 in act 370. API 105 then requests parameters and a return value from command object 302 (e.g., whether the operation succeeded or failed, any data component 160 was attempting to retrieve, such as a list of service packs installed, etc.). The parameters and return values are provided to API 105 in act 380, which then destroys command object 302 in act 385, and then provides the parameters and return values to component 160 in act 390. Example technique 300 then completes.

In some embodiments, when a component instructs API 105 to service a new image, API 105 may initialize a new command thread and queue to service the image. FIG. 4 is a sequence diagram depicting an example technique 400 for initializing a new command thread. Example technique 400 involves interaction between API 105, a command thread 401, a queue 402, and an image table 403.

At the start of example technique 400, API 105 receives a function call named “InitializeSession” in act 405. API 105 then constructs command thread 401 in act 410, causing command thread 401 to create queue 402 in act 415. The created queue is then identified to command thread 401 in act 420.

Command thread 401 identifies itself to API 105 in act 425, and API 105 then queries command thread 401 to identify queue 402 in act 430. Queue 402 is then identified to API 105 in act 435.

API 105 then inserts updates image table 403 with an indication of queue 402. To do so, API 105 acquires a lock on image table 403 in act 440, and then increments a global count of handles in act 445. API 105 then updates inserts an identification of queue 402 and the global handle count into image table 403 in act 450. API 105 then releases the lock on image table 403 in act 455, and begins the newly created command thread 401 in act 460. API 105 then provides a handle to the client process for use in referencing a particular image. Example process 400 then completes.

FIG. 5 is a sequence diagram depicting an example technique 500 for shutting down a command thread. In this respect, a command thread may be shut down if servicing of a corresponding image is no longer desired. API 105 may, in some embodiments, expose command thread shutdown functionality to one or more of components 160A-160E (FIG. 1) via a “ShutdownSession”. Example technique 500 involves interaction between API 105, an image table 501, a command object 502, a queue 503 and a command thread 504.

Example technique 500 begins when API 105 receives a call to invoke the ShutdownSession function in act 505. In the example shown, the call specifies a handle for a particular image. In act 510, API 105 then constructs a type of command object called “CommandObjectShutdown,” which is returned to API 105 in act 515.

API 105 then identifies the queue corresponding to the image. To do so, API 105 acquires a lock on image table 501 in act 520, and then queries the image table for the queue corresponding to the specified handle in act 525. The queue (i.e., queue 503) is identified to API 105 in act 530. API 105 then updates image table 501 to remove the queue entry corresponding to the handle in act 535.

In act 540, API 105 inserts command object 502 into queue 503. API 105 then releases the lock on the image table in act 545, and awaits completion of the command object in act 550.

In act 555, command thread 504 issues an instruction to read the command object in the queue, and the command object is returned to the command thread in act 560. Command thread 504 then executes command object 502 in act 565, which indicates to command thread 504 that the thread is to be shut down in act 570. When the command thread arrives at the processing command object shutdown, it calls the shutdown command objects execute function as usual. The execute function tells the command thread to exit its processing loop. Completion of this event is then signaled in act 575.

The command object 502 then waits for a specified period for command thread 504 to shut down in act 580. In act 585, the wait period completes. An indication that the wait has completed is passed by command object 502 to API 105 in act 590. API 105 then issues a command to destroy command thread 504 in act 592, which causes command thread 504 to issue a command to destroy queue 503 in act 594. By removing the queue associated with the handle from the image table, this prevents other client threads from scheduling operations on this image once the shutdown command has been initiated. API 105 then destroys command object 502 in act 596, and then signals to component 160 that the command thread shutdown operation has completed in act 598. Example technique 500 then completes.

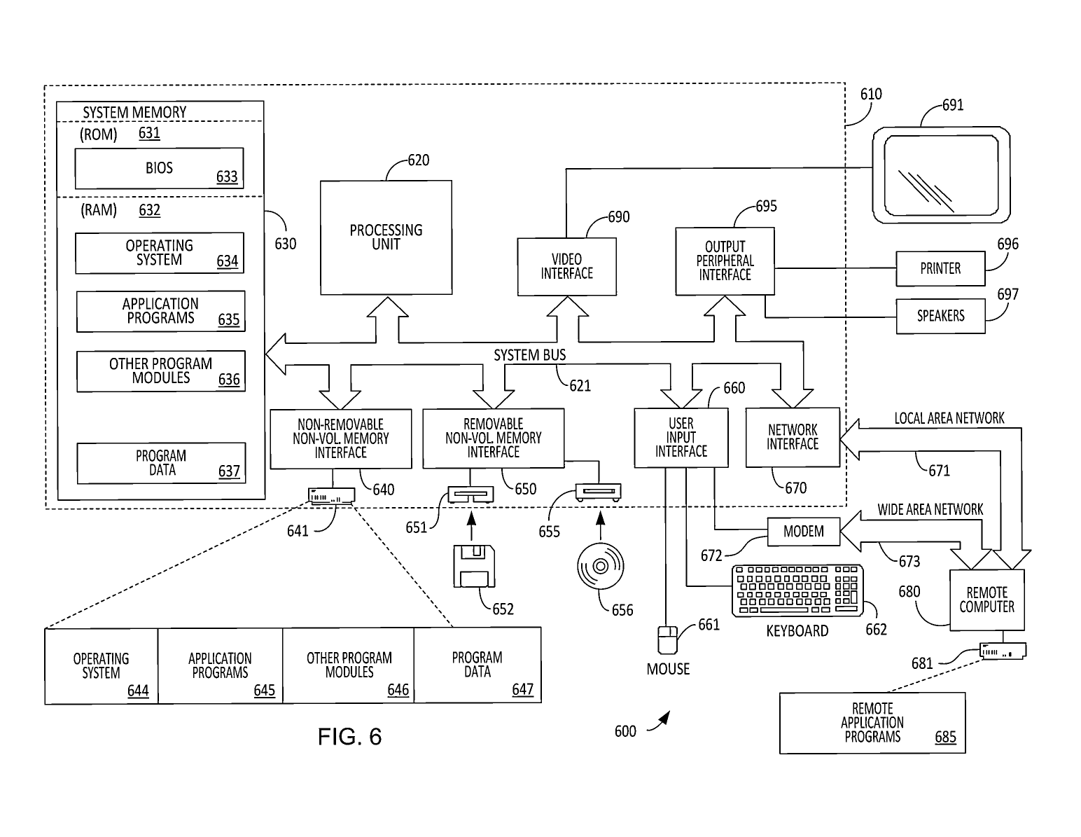

FIG. 6 illustrates an example of a suitable computing system environment 600 on which the invention may be implemented. The computing system environment 600 is only one example of a suitable computing environment and is not intended to suggest any limitation as to the scope of use or functionality of the invention. Embodiments of the invention described herein are not limited to being implemented using any one or combination of components illustrated in the exemplary operating environment 600.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 6, an exemplary system for implementing the invention includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through a output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
(A) receiving at least one instruction to perform an operation on a plurality of operating system images; and
(B) performing the operation on the plurality of operating system images;
wherein a time period during which the operation is performed on one of the plurality of operating system images overlaps with a time period during which the operation is performed on another of the plurality of operating system images.

2. The method of claim 1, wherein each of the plurality of operating system images is referenced by a handle, and the at least one instruction received in (A) references the handle for each of the plurality of operating system images.

3. The method of claim 1, wherein (B) comprises creating a command object corresponding to the operation for each of the plurality of operating system images, and placing the command object for each one of the operating system images into a queue for the one operating system image.

4. The method of claim 3, wherein (B) comprises a command thread for each operating system image reading the command object from the queue for the operating system image.

5. The method of claim 1, wherein at least one of the plurality of operating system images is not executing when the operation is performed in (B).

6. The method of claim 1, wherein the operation for which the at least one instruction is received in (A) is one of a plurality of operations to be performed on at least one of the plurality of operating system images.

7. The method of claim 1, wherein (A) and (B) are performed without booting any of the plurality of operating system images.

8. At least one computer-readable storage medium having instructions encoded thereon which, when executed, perform a method comprising:
(A) receive, at an application programming interface from at least one computer-executable component, an instruction to perform an operation on at least one operating system image; and
(B) cause, via communication between the application programming interface and the at least one operating system image, the operation for which the instruction was received in (A) to be performed on the at least one operating system image.

9. The at least one computer-readable storage medium of claim 8, wherein (A) comprises receiving an instruction to invoke functionality supplied by a provider component that is included in the operating system image.

10. The at least one computer-readable storage medium of claim 9, wherein (B) comprises communicating the instruction to a host component that is included in the operating system image and that oversees execution of the provider component.

11. The at least one computer-readable storage medium of claim 8, wherein the at least one computer-executable component comprises a user interface that is external to the application programming interface.

12. The at least one computer-readable storage medium of claim 8, wherein the at least one computer-executable component supplies functionality relating to servicing an operating system image.

13. The at least one computer-readable storage medium of claim 8, wherein (A) comprises receiving an instruction to perform the operation on a plurality of operating system images, and (B) comprises causing the operation to be performed on all of the plurality of operating system images.

14. An apparatus, comprising:
at least one computer processor, programmed to:
receive, from at least one computer-executable component, at least one instruction to perform an operation on a plurality of operating system images;
cause the operation for which the instruction was received to be performed on the plurality of operating system images;
wherein a time period during which the operation is performed on one of the plurality of operating system images overlaps with a time period during which the operation is performed on another of the plurality of operating system images.

15. The apparatus of claim 14, wherein each of the plurality of operating system images is referenced by a handle, and wherein the at least one computer processor is programmed to receive at least one instruction referencing the handle for each of the plurality of operating system images.

16. The apparatus of claim 14, wherein the at least one computer processor is programmed to create a command object for the operation for each of the plurality of operating system images, and to place the command object for each one of the operating system images into a queue for the one operating system image.

17. The apparatus of claim 14, wherein the at least one computer processor is programmed to receive instructions to perform a plurality of operations on at least one of the plurality of operating system images.

18. The apparatus of claim 14, wherein the at least one computer processor is programmed to receive an instruction to invoke functionality supplied by a provider component that is included in each of the plurality of operating system images.

19. The apparatus of claim 14, wherein the at least one computer processor is programmed to cause the operation to be performed by communicating the at least one instruction to a host component that is included in each of the operating system images, and that oversees execution of the provider component.

20. The apparatus of claim 14, wherein the at least one computer processor is programmed to cause the operation for which the instruction was received to be performed on all of the plurality of operating system images without booting any of the plurality of operating system images.
